(19) United States
(12) Patent Application Publication
(10) Pub. No.: US 2006/0182491 A1
(43) Pub. Date: Aug. 17, 2006

(54) Ball-and-socket joint

(75) Inventors: Peter Bernhardt, Wuppertal (DE); Ulrich Mette, Essen (DE)

Correspondence Address: MACMILLAN, SOBANSKI & TODD, LLC, ONE MARITIME PLAZA - FOURTH FLOOR, 720 WATER STREET, TOLEDO, OH, 43604, US

(73) Assignee: TRW Automotive GmbH

(21) Appl. No.: 11/353,757

(22) Filed: Feb. 14, 2006

(30) Foreign Application Priority Data
Feb. 15, 2005 (DE) 10 2005 006 884.7

(51) Int. Cl. F16D 1/12

(52) U.S. Cl. 403/134

(57) ABSTRACT

A ball-and-socket joint includes a joint housing and a pivot pin, the pivot pin having a ball section and a pin section, the ball section being pivotally mounted in the joint housing. A sealing bellows is provided for protecting a region between the joint housing and the pivot pin, and a fastening ring is provided in the interior of the sealing bellows, the fastening ring being locked with one of the joint housing and the pivot pin.

### CROSS-REFERENCE TO RELATED APPLIDCATION

This application claims priority to German Patent Application No. 10 2005 006 884.7 filed Feb. 15, 2005, the disclosures of which are incorporated herein by reference.

### BACKGROUND OF THE INVENTION

The invention relates to a ball-and-socket joint including a joint housing and a pivot pin, the pivot pin having a ball section and a pin section, the ball section being pivotally mounted in the joint housing, and a sealing bellows being provided for protecting the region between the joint housing and the pivot pin.

Ball-and-socket joints of the type stated are known from the prior art and are used in a great variety of embodiments. In particular in the construction of motor vehicles, substantially all the ball-and-socket joints have to be protected with the aid of sealing bellows or sealing collars against dirt and humidity. Therefore, a sealing bellows must, on the one hand, be sealingly and reliably attached to the joint housing and to the pivot pin, on the other hand, however, it must not restrict the options of the ball-and-socket joint to move, or be damaged by movements of the joint. A sealing bellows is usually attached to the joint housing or the pivot pin by means of additional fasteners such as a wire ring, claw or sheet metal rings. In the production of joints, these fasteners are in most cases applied in an additional work step after the assembly of the sealing bellows. With fasteners that are metallic as a rule, a build-up of corrosion and depositions of dirt occur on account of external influences owing to the exposed attachment on the outside. This has an unfavourable effect on the sealing bellows and may possibly damage it.

DE 101 24 295 C2, and corresponding U.S. patent application US 2003/0202842, both of which are incorporated by reference herein in entirety, discloses a ball-and-socket joint of the type mentioned above, in which the sealing bellows, as described above, is attached by outer lock washers. It is the object of the document cited to create a high-quality sealing seat by providing a particular sliding joint between the pin part and the sealing bellows.

### BRIEF SUMMARY OF THE INVENTION

The present invention is a simplified and cost-effective assembly of the sealing bellows and an improvement of the durability of the sealing bellows and the fasteners thereof.

This is achieved in a ball-and-socket joint including a joint housing and a pivot pin, the pivot pin having a ball section and a pin section, the ball section being pivotally mounted in the joint housing, a sealing bellows being provided for protecting a region between the joint housing and the pivot pin, and a fastening ring being provided in the interior of the sealing bellows, the fastening ring being locked with one of the joint housing and the pivot pin.

Thus, the fastening ring is protected and, moreover, the sealing bellows may be assembled and fastened in one work step.

In one embodiment, the fastening ring is adherently attached to the sealing bellows. This results in a particularly tight connection between the fastening ring and the sealing bellows.

In another embodiment, the fastening ring is a separate insert. In this embodiment, the fastening ring and the sealing bellows also form a preassembled unit which, however, is less expensive in the manufacture.

Preferably, the fastening ring is made of a corrosion-free material. Although the fastening ring is already well protected on account of its position in the interior of the sealing bellows, this measure leads to a particularly long-lasting and reliable fastening of the sealing bellows. In addition, the manufacture of the fastening ring of a corrosion-free material (e.g. plastic material) is possibly less expensive than the use of a metallic material (e.g. steel).

The fastening ring may be elastic and/or slotted on one side. Thus, a latching connection may particularly well be established, since the fastening ring may be radially widened and subsequently autonomously snaps back again into its initial position. The plastic material is not under stress. A flowing or settling is prevented.

Preferably, a latching section is provided at the fastening ring and a further latching section is provided at the joint housing and/or at the pivot pin, the latching sections establishing a connection that presses the sealing bellows in the radial and axial directions sealingly against the joint housing or the pivot pin. Thus, the latching connection does not only provide for a reliable fastening of the sealing bellows at the joint housing or at the pivot pin, but also for the necessary sealing arrangement between the corresponding components.

The fastening ring may be integrally connected to an additional ring which extends up to the outside of the sealing bellows. This provides for a stiffening of the sealing bellows in the joining region. The locking between the sealing bellows and the joint housing or the pivot pin may thereby be established better, and with embodiments in which the fastening ring is adherently attached to the sealing bellows, this additional ring results in a larger adhesive surface and thus a stronger connection between the sealing bellows and the two rings.

Other advantages of this invention will become apparent to those skilled in the art from the following detailed description of the preferred embodiments, which read in light of the accompanying drawings.

### BRIEF DESCRIPTION OF THE DRAWINGS

FIG. 1a shows a longitudinal section through a sealing bellows and a fastening ring;

FIG. 1b shows a longitudinal section through a preassembled unit consisting of the sealing bellows and the fastening ring of FIG. 1a;

FIG. 2 shows a longitudinal section through a ball-and-socket joint in accordance with the invention according to a first embodiment;

FIG. 3 shows a longitudinal section through a ball-and-socket joint in accordance with the invention according to a second embodiment;

FIG. 4 shows a detail of a longitudinal section through a ball-and-socket joint in accordance with the invention according to a third embodiment;

FIG. 5 shows a detail of a longitudinal section through a ball-and-socket joint in accordance with the invention according to a fourth embodiment;

FIG. 6 shows a detail of a longitudinal section through a ball-and-socket joint in accordance with the invention according to a fifth embodiment;

FIG. 7 shows a detail of a longitudinal section through a ball-and-socket joint in accordance with the invention according to a sixth embodiment;

FIG. 8 shows a longitudinal section through a ball-and-socket joint in accordance with the invention according to a seventh embodiment;

FIG. 9 shows a detail of a longitudinal section through a ball-and-socket joint in accordance with the invention according to an eighth embodiment; and

FIG. 10 shows a semi-section through a ball-and-socket joint in accordance with the invention according to a ninth embodiment.

### DETAILED DESCRIPTION OF THE INVENTION

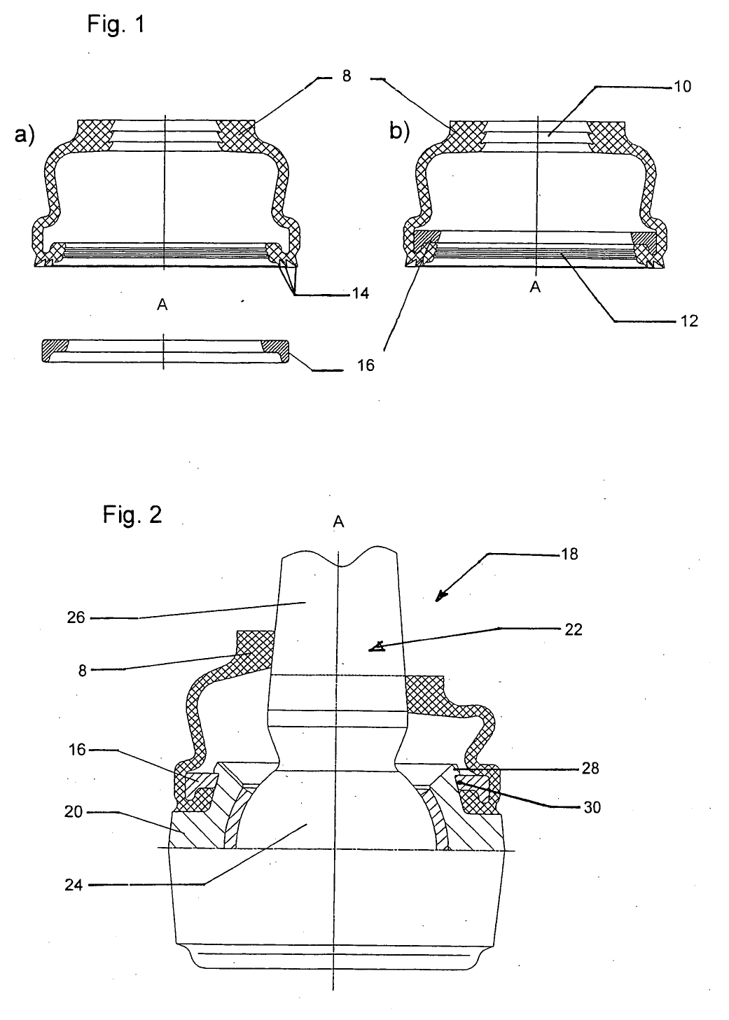

FIG. 1a shows a longitudinal section through a sealing bellows 8 that is rotationally symmetrical with respect to a center axis A and is made of a resilient, elastic and sealing material. The sealing bellows 8 comprises an upper axial opening 10 and a lower axial opening 12. In order to later on obtain a particularly tight and reliable connection in the radial direction, both openings 10, 12 are profiled at their edges. In FIG. 1a, this profile is formed of a plurality of surrounding protrusions which are directed radially inwards. In addition, downwardly protruding sealing lips 14 are disposed in the circumferential region of the lower axial opening 12 ensuring an axial sealing in the installed state.

Further represented in FIG. 1a below the sealing bellows 8 is a fastening ring 16 that is preferably made of a corrosion-free material. In the region of the lower axial opening 12 of the sealing bellows 8, the latter is shaped such that it exactly matches the contours of the fastening ring 16.

In FIG. 1b, the fastening ring 16 is placed in the provided recess of the sealing bellows 8. On account of the matching contours the fastening ring 16 is seated so tightly that the sealing bellows 8 and the fastening ring 16 form a preassembled unit.

FIG. 2 shows a ball-and-socket joint 18 including a joint housing 20 and a pivot pin 22 that comprises a ball section 24 and a pin section 26. The ball section 24 is pivotally mounted in the joint housing 20, the preassembled unit consisting of the sealing bellows 8 and the fastening ring 16 corresponding to FIG. 1b being provided for protecting the region between the joint housing 20 and the pivot pin 22.

The joint housing 20 comprises a latching section in the shape of a latching nose 28 whose outer diameter is larger than the inner diameter of the fastening ring 16. Axially below this latching nose 28, the diameter of the joint housing 20 decreases at first and then widens again. By means of the widening a contact surface is created which, when the sealing bellows 8 is mounted, comes into contact with the sealing lips 14 and forms together with the latter a sealing arrangement between the joint housing 20 and sealing bellows 8.

The sealing bellows 8 is mounted in one work step axially from above. In the process, it is passed over the pin section 26 of the pivot pin 22, until the fastening ring 16 locks into place at the joint housing 20. The fastening ring 16 likewise comprises a latching section 30 that includes a chamfered contact surface just like the latching nose 28.

In mounting the sealing bellows 8, the chamfered surface of the latching nose 28 is caused to rest against the chamfered surface of the latching section 30. By means of a downward axial pressure these chamfered surfaces slide together, with the fastening ring 16 being widened. In the final position, the fastening ring 16 snaps back into its smaller initial diameter and is prevented from slipping back by the latching nose 28. The required widening of the fastening ring 16 may be implemented by the fastening ring 16 being elastic and/or slotted on one side.

The dimensions of the sealing bellows 8 including its fastening ring 16 and the joint housing 20 are coordinated with each other in such a manner that the latching sections establish a reliable firm connection and simultaneously press the sealing bellows 8 in the radial and axial directions sealingly against the joint housing 20. In doing so, small dimensional tolerances may be compensated by the sealing lips 14 and the profile at the rim of the lower axial opening 12.

The profile along the inner periphery of the upper axial opening 10 is caused to rest against the pin section 26 of the pivot pin 22 during the assembly of the sealing bellows 8. This is apparent on the left-hand side of FIG. 2. In order to create a safe and tight connection, the sealing bellows 8 is pressed axially downwards at its upper axial opening 10. This is apparent in FIG. 2 on the right-hand side. Thereby, the upper axial opening 10 is radially widened, and the sealing bellows preferably rests safely against the pin section 26 of the pivot pin 22 on account of its inherent elasticity. Of course, this connection may additionally be supported by a groove provided in the pin section, or in the absence of an inherent elasticity it is possible to provide an insert in the region of the upper axial opening of the sealing bellows 8 ensuring an adequate connection.

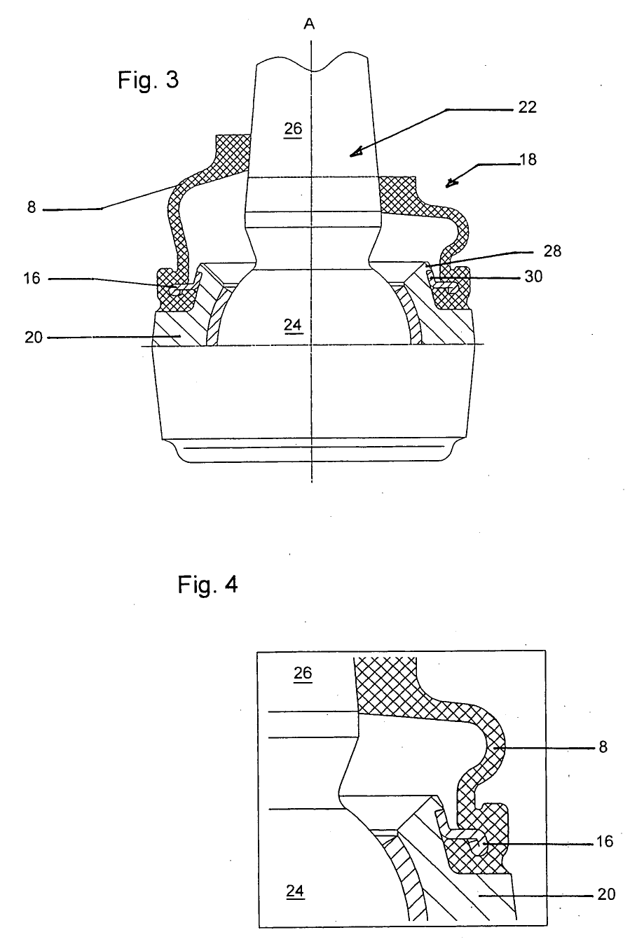

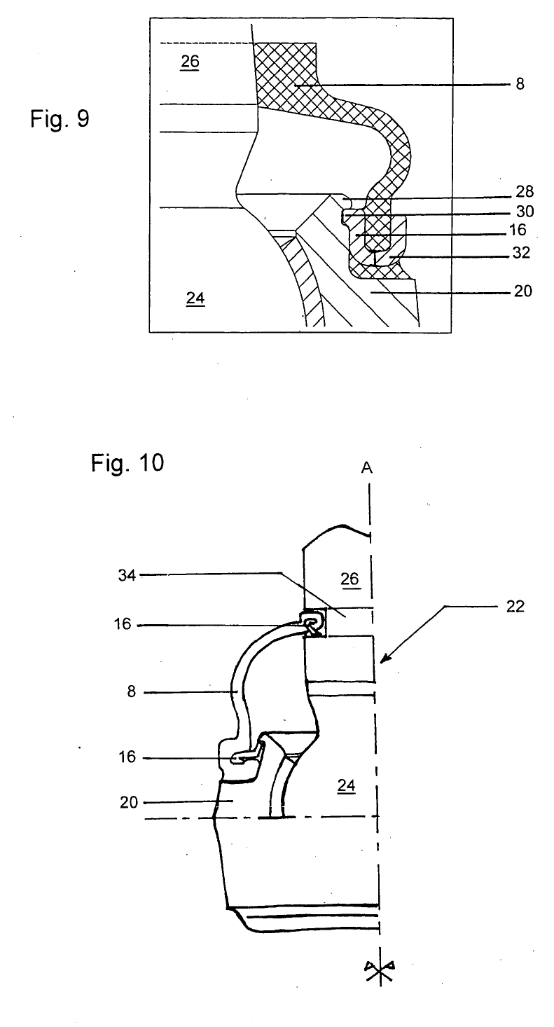

FIGS. 3 to 10 show preferred embodiments of the fastening ring 16, the function and the assembly being analogous to the embodiment described above. In FIGS. 3 to 7, the fastening ring 16 is configured as a separate insert, in FIGS. 8 and 9 examples are found for an adherent connection between the sealing bellows 8 and the fastening ring 16.

In the embodiment according to FIG. 3, the fastening ring 16 is made of a strip of constant thickness that is deformed in cross section. When selecting this cross-sectional shape, the use of sheet metal as the material for the fastening ring is, therefore, particularly advantageous.

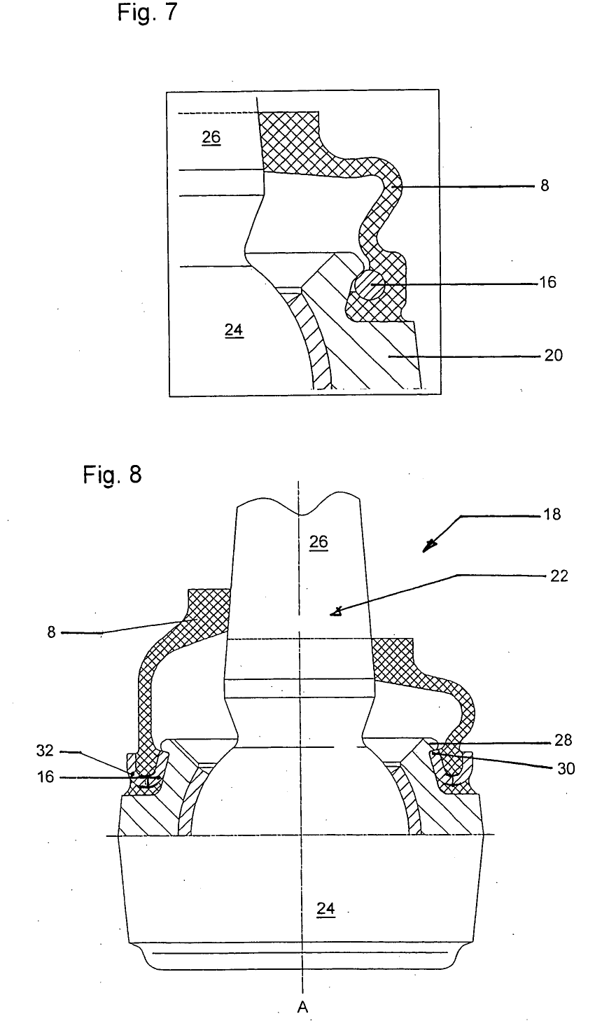

In FIG. 4, only the joining region between the sealing bellows 8 and the joint housing 20 is still visible in detail. The cross section of the fastening ring 16 is similar to that of FIG. 3, but bent downwards within the sealing bellows. This cross-sectional shape is also preferably provided for a sheet metal configuration of the fastening ring 16. The tensioning means (FIGS. 6 and 7) are to be installed on both sides (symmetrically).

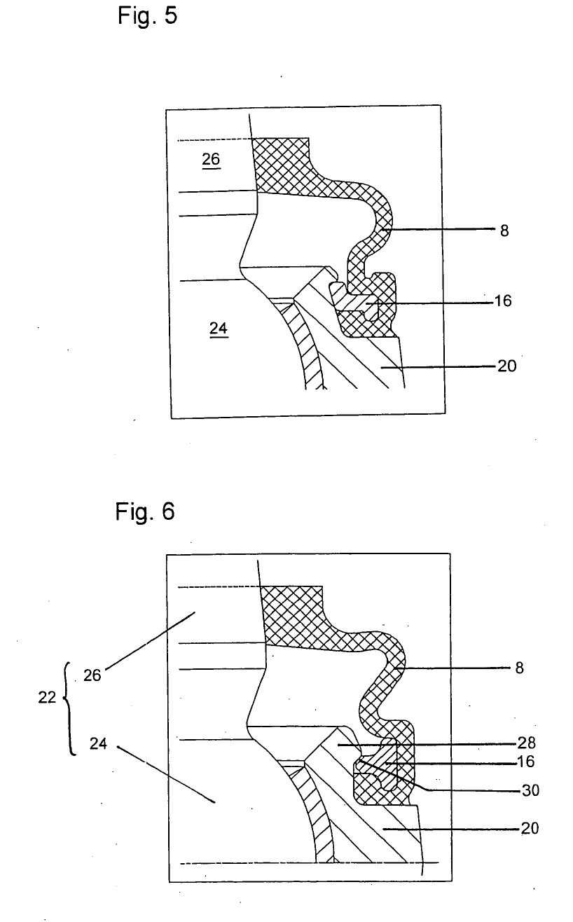

FIGS. 5 to 7 show the same detail as FIG. 4, the cross section of the fastening ring 16 being S-shaped (FIG. 5), T-shaped (FIG. 6), or circular (FIG. 7). When selecting this cross section, metals and plastic materials are particularly well suited as the manufacturing materials for the fastening ring 16, but any other materials or material compounds may, of course, be employed as well.

FIG. 8 shows a longitudinal section through a ball-and-socket joint 18 including a sealing bellows 8, a fastening ring 16, and an additional ring 32, the fastening ring 16 and the additional ring 32 being adherently attached to the sealing bellows. In the present embodiment, the additional ring 32 is made of the same material as the fastening ring 16 and integrally connected thereto. The fastening ring 16 is still securely accommodated in the interior of the sealing bellows 8 and provides for the latching connection to the joint housing 20. The additional ring 32 adjoins the fastening ring 16 and extends through the sealing bellows 8 up to the outside of the latter. On the whole, a U-shaped cross section materializes, which consists of two functionally different rings. Whilst the fastening ring provides for a reliable and tight connection between the sealing bellows 8 and the joint housing 20, the additional ring 32 offers an additional adhesive or connecting surface, which facilitates to establish an adherent connection (e.g. by vulcanizing or sticking together). Moreover, the entire joining region of the sealing bellows gains strength, whereby the reliability of the connection is increased.

FIG. 9 shows an embodiment of the fastening ring 16 that is very similar to the embodiment according to FIG. 8. The overall cross section of the outer additional ring 32 and the inner fastening ring 16 is likewise U-shaped, but the fastening ring 16 comprises a bent latching section 30.

In FIG. 10, there is represented a longitudinal section through a ball-and-socket joint that is rotationally symmetrical with respect to the axis A, both the connection between the sealing bellows 8 and the joint housing 20 and the connection between the sealing bellows 8 and the pivot pin 22 being configured as a latching connection. Configured for this purpose at the pin section 26 of the pivot pin 22 is a surrounding groove 34 into which the upper fastening ring 16 snaps into place. Of course, also in this embodiment the fastening rings 16 may comprise any other cross sectional shapes than those represented. Moreover, embodiments are conceivable as well, in which solely the pivot pin 22 is locked with the sealing bellows 8, and an alternative connection is provided for the connection between the sealing bellows 8 and the joint housing 20.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

What is claimed is:

1. A ball-and-socket joint including a joint housing and a pivot pin, said pivot pin having a ball section and a pin section, said ball section being pivotally mounted in said joint housing, a sealing bellows being provided for protecting a region between said joint housing and said pivot pin, and a fastening ring being provided in an interior of said sealing bellows, said fastening ring being locked with one of said joint housing and said pivot pin.

2. The ball-and-socket joint according to claim 1, wherein said fastening ring is adherently attached to said sealing bellows.

3. The ball-and-socket joint according to claim 1, wherein said fastening ring is preassembled at said sealing bellows as a separate insert.

4. The ball-and-socket joint according to claim 1, wherein said fastening ring is made of a corrosion-free material.

5. The ball-and-socket joint according to claim 1, wherein said fastening ring is at least one of elastic and slotted on one side.

6. The ball-and-socket joint according to claim 1, wherein a latching section is provided at said fastening ring, and a further latching section is provided at at least one of said joint housing and said pivot pin.

7. The ball-and-socket joint according to claim 6, wherein said latching sections establish a connection pressing said sealing bellows in a radial and an axial direction sealingly against at least one of said joint housing and said pivot pin.

8. The ball-and-socket joint according to claim 1, wherein said fastening ring is integrally connected to an additional ring, said additional ring extending up to an outside of said sealing bellows.
